(19) United States
(12) Patent Application Publication
(10) Pub. No.: US 2019/0224942 A1
(43) Pub. Date: Jul. 25, 2019

(54) VISIBILITY IMPROVEMENT FILM, LAMINATE COMPRISING SAME, AND IMAGE DISPLAY DEVICE COMPRISING SAME

(71) Applicant: JXTG NIPPON OIL & ENERGY CORPORATION, Tokyo (JP)

(72) Inventors: Akira MATSUO, Tokyo-to (JP); Tetsuya UESAKA, Tokyo-to (JP); Tatsuya KAWABATA, Tokyo-to (JP)

(73) Assignee: JXTG NIPPON OIL & ENERGY CORPORATION, Tokyo (JP)

(21) Appl. No.: 16/317,157

(22) PCT Filed: Jul. 7, 2017
(86) PCT No.: PCT/JP2017/025004

§ 371 Date: Jan. 11, 2019

(30) Foreign Application Priority Data
Jul. 13, 2016 (JP) 2016-138543

(51) Int. Cl. B32B 7/023; G02B 5/02; B32B 27/20; B32B 27/24; B32B 27/26; G02B 5/30

(52) U.S. Cl. CPC B32B 7/023; G02B 5/0205; G02B 5/3025; B32B 27/24; B32B 27/26; B32B 27/20

(57) ABSTRACT

[Problem] Provided is a visibility improvement film for improving visibility of laser light beam irradiated on a display screen of an image display device.

[Solving means] According to the present invention, there is provided a visibility improvement film for use for improving the visibility of laser light beam irradiated on a display screen of an image display device, wherein
the visibility improvement film comprises a transparent light scattering layer comprising a binder, and at least either one of 0.0001 to 1.0% by mass of light reflective microparticles and light diffusive microparticles, based on the binder.

### BACKGROUND OF THE INVENTION

### Field of the Invention

The present invention relates to a visibility improvement film which enables to clearly visualize light irradiated from a laser light irradiation device such as a laser pointer against an image display screen such as an electronic black board, a digital signage or the like. The present invention also relates to a laminate and an image display device comprising the visibility improvement film.

### Background Art

Laser light irradiation such as a laser pointer has been used conventionally for performing presentations in an effective manner. A laser pointer is a device that irradiates a laser light beam in high brightness and in red or green color to the part where the person performing the presentation wishes to draw attention of the audience for certain words or images while displaying a presentation material on the image display device.

There was a problem in some image display devices that since there is no member equipped to scatter light in the rear direction, the irradiated laser light beam cannot be visualized when the laser light beam was irradiated on the display screen of the image display device such as a screen, an electronic blackboard, a digital signage or the like, or even if it was visualized, the laser light beam was vague, resulting in decrease of the effect for drawing attention. In order to solve the problem, the outline of the laser light beam is expected to become clear by laminating on an image display device, a laser-pointer visibility improvement film as described in Patent Document 1, a film to which an upconversion type luminescent material is dispersed as described in Patent Document 2, or a film having a fine concave-convex structure on the surface as described in Patent Document 3.

### PRIOR ART

### Patent Document

[Patent Document 1] Japanese Unexamined Patent Application Publication No. 2009-217065

[Patent Document 2] WO2015/046541

[Patent Document 1] Japanese Unexamined Patent Application Publication No. 2008-233870

### SUMMARY OF THE INVENTION

### Problem to be Solved

However the present inventors have found the following technical problems when the films as described in Patent Documents 1 to 3 are laminated. The visibility improvement film as described in Patent Document 1 is a film which has a visibility resin layer comprising microparticles; however since the microparticles are blended in the visibility resin layer in a high concentration and the haze value is high, there was a problem that the visibility of the image displayed is compromised. The film as described in Patent Document 2 is a film to which an upconversion type luminescent material is dispersed and there was a problem that since generally the upconversion type luminescent material has a low quantum yield, the laser light on the image display device resulted in low brilliance and uneasily visualized. When a film having a fine concave-convex structure on the surface as described in Patent Document 3 was laminated, the clarity of the laser light beam was improved; however there was a problem that the visibility of the displayed image was impaired due to the scattering light caused by the concave-convex surface.

### Means to Solve the Problem

In order to solve the above described technical problems, the present inventors intensively studied to find that the above described technical problems can be solved by laminating a visibility improvement film comprising a transparent light scattering layer to which at least one of the bright flake-form microparticles and the substantially spherical microparticles are dispersed. The present invention has been completed upon these findings.

According to the first aspect of the present invention, there is provided a visibility improvement film for use for improving the visibility of laser light beam irradiated on a display screen of an image display device, wherein

the visibility improvement film comprises a transparent light scattering layer comprising a binder, and at least either one of 0.0001 to 1.0% by mass of light reflective microparticles and light diffusive microparticles, based on the binder.

In one aspect of the present invention, the average particle size of the primary particles of the light reflective microparticles is preferably from 0.01 to 100 μm.

In one aspect of the present invention, the light reflective microparticles preferably have a shape of a flake form, an average aspect ratio of from 3 to 800, and a regular reflectance of from 12 to 100.

In one aspect of the present invention, the light reflective microparticles are preferably metallic particles selected from the group consisting of aluminum, silver, platinum, gold, titanium, nickel, tin, indium, chromium, titanium oxide, aluminum oxide, and zinc sulfide, bright materials of glass coated with metal or metallic oxide, or bright materials of natural or synthetic mica coated with metal or metallic oxide to natural or synthetic mica.

In one aspect of the present invention, the difference between refractive index n₂ of the light diffusive microparticles and refractive index n₁ of the binder preferably satisfies the following formula (1):

|n₁−n₂|≥0.1 (1).

In one aspect of the present invention, the light diffusive microparticles preferably are at least one selected from the group consisting of zirconium oxide, zinc oxide, titanium oxide, cerium oxide, barium titanate, strontium titanate, magnesium oxide, calcium carbonate, barium sulfate, and diamond.

In one aspect of the present invention, the light diffusive microparticles preferably have a median diameter of the primary particles of from 0.1 to 500 nm.

In one aspect of the present invention, the haze of the visibility improvement film is preferably 35% or less.

According to another aspect of the present invention, there is provided a laminate comprising the visibility improvement film and the polarizer.

According to another aspect of the present invention, there is provided an image display device comprising the visibility improvement film or the laminate.

In another aspect of the present invention, there is provided a video image projection system comprising the image display device comprising the visibility improvement film or the laminate, and a projection device.

### Effect of the Invention

According to the present invention, it is possible to provide a visibility improvement film which improves the visibility of laser light irradiated from a laser light irradiation device such as a laser pointer to an image display device and which further does not impair the visibility of presentation materials or the like, displayed on the image display device. By using such visibility improvement film, it is possible to provide an image display device and an image projection system that allow an effective presentation.

### BRIEF DESCRIPTION OF THE DRAWINGS

FIG. 1 is a sectional view in the thickness direction of one embodiment of the visibility improvement film according to the present invention.

FIG. 2 is a sectional view in the thickness direction of one embodiment of the laminate according to the present invention.

FIG. 3 is a sectional view in the thickness direction of one embodiment of the laminate according to the present invention.

### MODE FOR CARRYING OUT THE INVENTION

### <Visibility Improvement Film>

The visibility improvement film in relation to the present invention is used for improving the visibility of the laser light beam irradiated on the display screen of the image display device, and has a transparent light scattering layer. The transparent light scattering layer comprises a binder, and at least either one of light reflective microparticles and light diffusive microparticles. In the present invention, “transparent” means transparent in the degree the transmission visibility in accordance with applications can be attained and includes “translucent”.

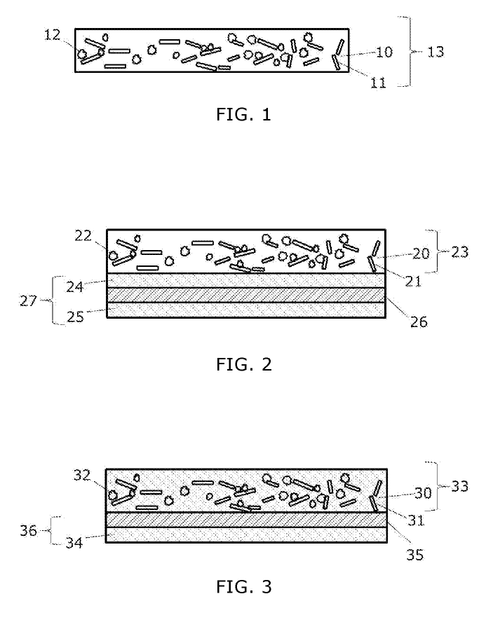

A sectional diagram in the thickness direction of one embodiment of the visibility improvement film according to the present invention is shown in FIG. 1. The visibility improvement film is consisted of transparent light scattering layer 13 in which light reflective microparticles 11 and light diffusive microparticles 12 are dispersed in binder 10. The transparent light scattering layer 13 may comprise only one of either the light reflective microparticles 11 or the light diffusive microparticles 12.

A sectional diagram in the thickness direction of one embodiment of the laminate according to the present invention is shown in FIG. 2. The laminate is formed by laminating polarizer 26, and polarization plate 27 of which both sides are protected with polarizer protection layers 24 and 25, and transparent light scattering layer 23, and the transparent light scattering layer 23 is formed of light reflective microparticles 23 and light diffusive microparticles 22 dispersed in binder 20. The transparent light scattering layer 23 may comprise only one of either the light reflective microparticles 21 or the light diffusive microparticles 22.

A sectional diagram in the thickness direction of one embodiment of the laminate according to the present invention is shown in FIG. 3. The laminate is formed by laminating polarizer 35, and polarization plate 36 of which one side is protected with polarizer protection layer 34, and polarizer protection layer 33 which has a function of the transparent light scattering layer. The polarizer protection layer 33 having a function of the transparent light scattering layer is formed of light reflective microparticles 31 and light diffusive microparticles 32 dispersed in binder 30. The polarizer protection layer 33 which has a function of the transparent light scattering layer may comprise only one of either the light reflective microparticles 31 or the light diffusive microparticles 32.

### (Transparent Light Scattering Layer)

The haze value of the transparent light scattering layer is preferably 35% or less, more preferably from 1% to 30%, more preferably from 1.3% to 20%, further more preferably from 1.5% to 15%, and most preferably from 2% to 10%. The total light beam transmittance is preferably 70% or more, more preferably 75% or more, further preferably 80% or more, and further more preferably 85% or more. The diffusion transmittance of the transparent light scattering layer is preferably from 1.5% to 50%, more preferably from 1.7% to 45%, more preferably from 1.9% to 40%, and further more preferably from 2.0% to 38%. When the haze value and the total light beam transmittance are within the above ranges, high transparency can be achieved and the visibility of the displayed image can be maintained, and when the diffusion transmittance is within the above ranges, entering light is efficiently diffused to result in excellent laser light clearness. In the present invention, the haze value, the total light beam transmittance, and the diffusion transmittance of the transparent light scattering layer can be measured with a turbidimeter (Part No.: NDH-5000; manufactured by NIPPON DENSHOKU INDUSTRIES CO., LTD.), in accordance with JIS-K-7361 and JIS-K-7136.

The image clarity of the transparent light scattering layer is preferably 70% or more, more preferably 75% or more, further preferably 80% or more, further more preferably 85% or more, and especially more preferably 90% or more. When the image clarity of the transparent light scattering layer is within the above ranges, the image seen through the transparent light scattering layer becomes extremely clear. In the present invention, the image clarity is the value of image definition measured at an optical comb width of 0.125 mm, in accordance with JIS K7374.

Reflected frontal luminous intensity of the transparent light scattering layer is preferably from 3 to 60 or less, more preferably from 4 to 50 or less, and further preferably from 4.5 to 40 or less. Transmitted frontal luminous intensity of the transparent light scattering layer is preferably 1.5 or more, more preferably 2.0 or more, and further more preferably from 3.0 to 50 or less. When the reflected and transmitted frontal luminous intensity of the transparent light scattering layer are within the above-described ranges, the brightness of the reflection light will be high, resulting in excellent clearness of the laser light. In the present invention, the elevation rates of the reflected and transmitted frontal luminous intensities of the transparent light scattering layer are values measured in such way as follows.

### (Reflected Frontal Luminous Intensity)

The reflected frontal luminous intensity is measured by using a goniophotometer (Part No.: GC5000L; manufactured by NIPPON DENSHOKU INDUSTRIES CO., LTD.). An entering angle of a light source is set to 45 degrees, and a reflected light intensity in the direction of 0 degree when a standard white-colored plate with whiteness degree of 95.77 was placed on the measuring stage is 100. When a sample is measured, the entering angle of the light source is set to 15 degrees and the intensity of the reflected light in the direction of 0 degree is measured.

### (Transmitted Frontal Luminous Intensity)

The transmitted frontal luminous intensity is measured by using a goniophotometer (Part No.: GC5000L; manufactured by NIPPON DENSHOKU INDUSTRIES CO., LTD.). An entering angle of a light source is set to 0 degree, and a transmitted light intensity in the direction of 0 degree with nothing placed on the measuring stage is 100. When a sample is measured, the entering angle of the light source is set to 15 degrees and the intensity of the transmitted light in the direction of 0 degree is measured.

The thickness of the transparent light scattering layer is, without particular limitation, preferably from 0.01 μm to 20 mm, more preferably from 0.1 μm to 15 mm, further preferably from 0.5 μm to 10 mm, and most preferably from 1 μm to 1 mm, in view of purpose, productivity, handling, and transportation. When the thickness of the transparent light scattering layer is within the above ranges, the transparent light scattering layer can fully exhibit its function. The transparent light scattering layer can be a single layer configuration, or may be of multiple layer configuration formed by laminating 2 or more layers by coating, etc.

### (Binder)

Any kind of materials may be used as the binder which forms the transparent light scattering layer, as long as they are highly transparent, and preference is made to using inorganic or organic binders.

The highly transparent inorganic binder includes, for example, liquid glass, a glass material having a low softening point, or a sol-gel material. Liquid glass is a solution rich in alkali silicate and normally sodium is contained as an alkali metal. A representative liquid glass can be expressed by Na₂O.nSiO₂ (n: any positive value). Commercially available liquid glass includes sodium silicate solution Nos. 1 to 3, and the ratio of SiO₂ to Na₂O becomes higher in this order. When water content was evaporated from the liquid glass, a shatter-resistant and elastic solid is formed containing about 10 to 30% by mass of water content called hydrated glass, whereby a function as a binder having an adherence property is exhibited. Optionally, K₂O may be partly included in place of Na₂O; however, even in such case, the molar ratio with SiO₂ is preferably within the above-described range. With respect to the function as a binder, the higher the molecular weight of the poly silicate ion contained in the liquid glass, the easier to form a cured film with a high mechanical intensity; however, sometimes cracks can be easily formed in the cured film and therefore, liquid glass is preferably used with an optimal molar ratio of SiO₂ to Na₂O, depending on, for example, concentration or pH and proportion to hydroxyapatite of the liquid glass to be contained when in use as a coating liquid. Sodium silicate manufactured by Fuji Kagaku Corp. can be used as liquid glass.

The glass material having a low softening point is a glass having a softening temperature preferably in the range from 150 to 620° C., more preferably from 200 to 600° C., and most preferably from 250 to 550° C. Such glass materials include a lead-free low softening point glass, or the like, obtainable by thermal treatment of a mixture comprising PbO—B₂O₃ based, PbO—B₂O₃—SiO₂ based, PbO—ZnO—B₂O₃ based acid component and metallic chloride. The low softening point glass material is preferably the so-called glass frit, which will melt in a curing step to be mentioned below. As for the low softening point glass material, preference is made to the use of powder having a median diameter in the range from 1 to 50 μm. In order to improve the dispersibility and formability of the microparticles, solvents and organic solvents having high boiling point can be mixed to the low softening point glass material.

Sol-gel materials are a group of compounds which hydrolytic polycondensation proceeds and the material cures by action of heat, light, catalysts, or the like. Examples may be metal alkoxide (metal alcoholate), a metal chelate compound, halogenated metal, fluid glass, a spin-on glass, or reactants thereof and catalysts may be included therein to accelerate curing. Those having photoreactive functional groups such as an acrylic group in a moiety of a metal alkoxide functional group may be also possible. These may be used alone or by combining multiple kinds, depending on the required physicality. A cured element of the sol-gel material refers to a state in which the polymerization reaction of the sol-gel material has been sufficiently progressed. The sol-gel material chemically bonds and strongly adheres to the surface of an inorganic substrate in the course of a polymerization reaction. Accordingly, by using a cured element of the sol-gel material as a cured layer, a stable cured layer can be formed.

Metal alkoxides are a group of compounds obtainable from a reaction of any metallic species with water or organic solvents by hydrolysis catalysts, and are a group of compounds which any metallic species and functional groups such as a hydroxyl group, a methoxy group, an ethoxy group, a propyl group, an isopropyl group, or the like, are bonded. Metallic species of a metal alkoxide include silicon, titanium, aluminum, germanium, boron, zirconium, tungsten, sodium, potassium, lithium, magnesium, tin, or the like.

A metal alkoxide in which the metallic species is silicon includes, for example, dimethyldiethoxysilane, diphenyldiethoxysilane, phenyltriethoxysilane, methyltriethoxysilane(MTES), vinyltriethoxysilane, p-styryltriethoxysilane, methylphenyldiethoxysilane, 2-(3,4-epoxycyclohexyl)ethyltriethoxysilane, 3-glycidoxypropyltriethoxysilane, 3-glycidoxypropylmethyldiethoxysilane, 3-methacryloxypropylmethyldiethoxysilane, 3-methacryloxypropyltriethoxysilane, 3-acryloxypropyltriethoxysilane, N-2-(aminoethyl)-3-aminopropylmethyldiethoxysilane, N-2-(aminoethyl)-3-aminopropyltriethoxysilane, 3-aminopropyltriethoxysilane, 3-ureidopropyltriethoxysilane, 3-mercaptopropylmethyldiethoxysilane, 3-mercaptopropyltriethoxysilane, triethoxysilane (TEOS), diphenylsilanediol, dimethylsilanediol, or a group of compounds where the ethoxy groups of these group of compounds are substituted with a methoxy group, a propyl group, an isopropyl group, a hydroxyl group, or the like. Amongst these, TEOS and tetramethoxysilane (TMOS) in which the ethoxy group of TEOS is substituted with a methoxy group are especially preferable. These may be used alone or by combining multiple kinds.

When TEOS, MTES or a combination thereof is used, the mixing ratio thereof may be, for example, 1:1 in a molar ratio. This sol solution generates amorphous silica by performing hydrolysis and a polycondensation reaction. As a synthesis condition, acid such as hydrochloric acid or alkaline such as ammonium is added to adjust the pH of the solution. The pH is preferably 4 or less or 10 or more. Water may also be added to carry out hydrolysis. The amount of water to be added can be more than 1.5 times or more in a molar ratio, based on the kind of metallic alkoxide.

A silsesquioxane compound may also be used for the metallic alkoxide. A silsesquioxane compound is a collective term for a group of compounds represented by SiO_{1.5} and is a compound in which one organic base and three oxygen atoms are bound to one silicon atom. A metallic halide is a compound group having a functional group to be hydrolysed and polycondensed, replaced by a halogen atom in the above-described metal alkoxide.

A metallic chelate compound includes titanium diisopropoxy bis(acetylacetonate), titanium tetrakis acetylacetonate, titanium dibutoxy bis(octyleneglycolate), zirconium tetrakis acetylacetonate, zirconium dibutoxy bis(acetylacetonate), aluminum tris acetylacetonate, aluminium dibutoxy mono(acetylacetonate), zinc bis(acetylacetonate), indium tris(acetylacetonate), polytitanium acetylacetonate, or the like.

A highly transparent organic binder includes a resin, for example, a thermoplastic resin, an ionizing radiation-curable resin, a thermoset resin, an adhesive, and the like. The thermoplastic resin may be one that dissolves easily in the solvent. As for such thermoplastic resin, for example, an acrylic resin, a polyester resin, a polyolefin resin, a vinyl resin, a polycarbonate resin, and a polystyrene resin can be used and methyl polymethacrylate resin, a polyethylene terephthalate resin, a polyethylene naphthalate resin, a polypropylene resin, a cycloolefin resin, a cellulose acetate propionate resin, a polyvinyl butyral resin, a polycarbonate resin, an ethylene-vinyl acetate copolymer resin, a nitrocellulose resin, and a polystyrene resin can be used. One of these resins may be used alone or two or more kinds may be used in combination. Examples of the ionizing radiation-curable resin include an acrylic resin, a urethane resin, an acrylic urethane resin, an epoxy resin, silicone resin, and the like. Among these, those having an acrylate functional group, for example, those containing a relatively large amount of a monofunctional monomer such as ethyl (meth)acrylate, ethylhexyl (meth)acrylate, styrene, methyl styrene, N-vinylpyrrolidone and a polyfunctional monomer, such as polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexane diol di(meth)acrylate, neopentyl glycol di(meth)acrylate as an oligomer or a prepolymer of a polyester resin, a polyether resin, an acrylic resin, an epoxy resin, a urethane resin, an alkyd resin, a spiroacetal resin, a polybutadiene resin, a polythiol polyene resin, a (meth)acrylate of a polyfunctional compound such as a polyalcohol and a reactivity diluent having a relatively low molecular weight are preferable. The ionizing radiation-curable resin may also be obtained by mixing a thermoplastic resin and a solvent and may be one used for a hard coat layer to impart scratch resistance or an anti-glaring property. The ionizing radiation-curable resin includes a silicone resin, an epoxy resin, a urethane resin, an acrylic resin, or the like. The thermoset resin includes a phenolic resin, an epoxy resin, a silicone resin, a melamine resin, a urethane resin, a urea resin, or the like. Amongst these, an epoxy resin and a silicone resin are preferable. The polyvinyl butyral resin and the ethylene-vinyl acetate copolymer resin from the thermoplastic resins have excellent adherence property against substrates such as glass, metals, ceramics, or the like, and they may be used as an adhesive. A commercially available product may be used for the organic binder, including for example, an acryl lacquer (RECRACK 73 Clear, manufactured by FUJIKURA KASEI CO., LTD.), an urethane acrylate type UV curable resin (UNIDIC V-4018 manufactured by DIC Company), and product name: EA-415 manufactured by SANYU REC. LTD., and the like.

The use of an organic binder as an adhesive will allow imparting an adherence property to the transparent light scattering layer. Examples of the adhesive include a natural rubber, a synthetic rubber, an acryl resin, a polyvinyl ether resin, a urethane resin, and a silicone resin. Specific examples of the synthetic rubber include a styrene-butadiene rubber, an acrylonitrile-butadiene rubber, a polyisobutylene rubber, an isobutylene-isoprene rubber, a styrene-isoprene block copolymer, a styrene-butadiene block copolymer, and a styrene-ethylene-butylene block copolymer. Specific examples of the silicone resin include a dimethyl polysiloxane and the like. One of these adhesives can be used alone or two or more kinds can be used in combination. Amongst these, an acrylic adhesive is preferable.

An acrylic resin adhesive is obtained by including at least an alkyl ester (meth)acrylate monomer and polymerization. Generally, it is a copolymer of an alkyl ester (meth)acrylate monomer having an alkyl group with about 1 to 18 carbon atoms and a monomer having a carboxyl group. A (meth)acrylic acid means an acrylic acid and/or a methacrylic acid. Examples of the alkyl ester (meth)acrylate monomer include methyl (meth)acrylate, ethyl (meth)acrylate, n-propyl (meth)acrylate, sec-propyl (meth)acrylate, n-butyl (meth)acrylate, sec-butyl (meth)acrylate, tert-butyl (meth)acrylate, isoamyl (meth)acrylate, n-hexyl (meth)acrylate, cyclo hexyl (meth)acrylate, n-octyl (meth)acrylate, isooctyl (meth)acrylate, 2-ethylhexyl (meth)acrylate, undecyl (meth)acrylate, and lauryl (meth)acrylate. The above-described alkyl ester (meth)acrylate is usually copolymerized at a ratio of 30 to 99.5 parts by mass in the acrylic adhesive.

The monomer having a carboxyl group, which forms the acrylic resin adhesive, are the monomers containing a carboxyl group such as (meth)acrylate, itaconic acid, crotonic acid, maleic acid, monobutyl maleate, and β-carboxyethyl acrylate.

Monomers having other functional groups may be copolymerized in the acrylic resin adhesive, apart from the ones described above, as long as it does not impart the property of the acrylic resin adhesive. Examples of the monomers having other functional groups include monomers containing a hydroxyl group such as 2-hydroxyethyl (meth)acrylate, 2-hydroxypropyl (meth)acrylate, and aryl alcohol; monomers containing an amide group such as (meth)acryl amide, N-methyl(meth)acryl amide, and N-ethyl(meth)acryl amide; monomers containing an amide group such as N-methylol (meth)acryl amide and dimethylol (meth)acryl amide and a methylol group; monomers having a functional group such as monomers containing amino groups of amino methyl(meth)acrylate, dimethyl amino methyl(meth)acrylate, and vinyl pyridine; monomers containing an epoxy group such as allyl glycidyl ether, glycidyl ether(meth)acrylate; and the like. Apart from these, there can be included, fluorine-substituted alkyl ester (meth) acrylate, (meth) acrylonitrile and others like aromatic compound containing a vinyl group such as styrene and methyl styrene, vinyl acetate, a halogenated vinyl compound, and the like.

As for the acrylic resin adhesive, other monomers having ethylenic double bonds may be used other than the above-described monomers having other functional groups. Examples of the monomers having ethylenic double bonds include a diester of an α,β-unsaturated dibasic acid such as dibutyl maleate, dioctyl maleate, and dibutyl fumarate; a vinyl ester such as vinyl acetate, vinyl propionate; vinyl ether; a vinyl aromatic compound such as styrene, α-methyl styrene, and vinyl toluene; and (meth)acrylonitrile. Other than the monomers having ethylenic double bonds as described above, a compound having two or more ethylenic double bonds can be used in combination. Examples of such compounds include divinylbenzene, diallyl maleate, diallyl phthalate, ethylene glycol di(meth)acrylate, trimethylol propane tri(meth)acrylate, and methylene bis(meth)acrylamide.

Commercially available products may be used as the adhesive, and for example, SK-Dyne 2094, SK-Dyne 2147, SK-Dyne 1811L, SK-Dyne 1442, SK-Dyne 1435, and SK-Dyne 1415 (all manufactured by Soken Chemical & Engineeing Co., Ltd.), ORIBAIN EG-655 and ORIBAIN BPS5896 (both manufactured by TOYO INK CO., LTD.), and the like (all, product name) can be suitably used.

The binder that forms the transparent light scattering layer according to the present invention may comprise a solvent in accordance with the production method of the transparent light scattering layer. The solvent is not limited to organic solvents, and solvents used in common coating compositions can be used. For example, it is possible to use hydrophilic solvents like water. When the binder of the present invention is liquid, there is no need to contain a solvent.

Specific examples of the solvent according to the present invention include, for example, alcohols such as methanol, ethonaol, isopropyl alcohol (IPA), n-propanol, butanol, 2-butanol, ethylene glycol, and propylene glycol; aliphatic carbon hydrides such as hexane, heptane, octane, decane, and cyclohexane; aromatic carbon hydrides such as benzene, toluene, xylene, mesitylene, and tetramethylbenzene; ethers such as diethylether, tetrahydrofuran, and dioxane; ketones such as acetone, methyl ethyl ketone, isophorone, cyclohexanone, cyclopentanone, and N-methyl-2-pyrrolidone; ether alcohols such as butoxyethyl ether, hexyloxy ethyl alcohol, methoxy-2-propanol, and benzyloxy ethanol; glycols such as ethylene glycol and propylene glycol; glycol ethers such as ethylene glycol dimethylether, diethylene glycol dimethyl ether, propylene glycol monomethyl ether acetate, cellosolve, methyl cellosolve, ethyl cellosolve, carbitol, methyl carbitol, ethyl carbitol, butyl carbitol, propylene glycol monomethyl ether, propylene glycol monoethyl ether, dipropylene glycol monomethyl ether, dipropylene glycol monoethyl ether, triethylene glycol monomethyl ether, and triethylene glycol monoethyl ether; esters such as ethyl acetate, butyl acetate, ethyl lactate, and γ-butylolactone; phenols such as phenol and chlorophenol; amides such as N,N-dimethyl formamide, N,N-dimethyl acetamide, and N-methylpyrrolidone; halogenated solvates such as chloroform, methylene chloride, tetrachloroethane, monochlorobenzene, and dichlorobenzene; hetero element containing compounds such as carbon bisulfide; water; and mixed solvates thereof. The amount of solvates to be added can be appropriately adjusted, depending on, for example, the kind of binders or microparticles, or the viscosity range suitable for the coating or spraying steps to be discussed below.

Conventionally known additives other than the microparticles may be added to the transparent light scattering layer depending on the purposes, as long as the transmission visibility and the desired optical performance of the transparent light scattering layer are not compromised. Examples of the additives include an antioxidant, a surfactant, a thickener, a compatibilzer, a nucleating agent, an ultraviolet absorber, a light stabilizer, an antistatic agent, a release agent, a flame retardant, a plasticizer, a lubricant, a color material, and the like. As for the color material, a pigment or dye such as carbon black, azo pigment, anthraquinone pigment, or perinone pigment can be used. A liquid crystalline compound or the like may be mixed thereto.

### (Light Reflective Microparticles)

As for the light reflective microparticles, bright materials which can be processed into flake form can be preferably used. The regular reflectance of the bright flake-form microparticles is preferably 12.0% or more, more preferably from 15.0% to 100%, and further preferably from 20.0% to 95%. In the present invention, the regular reflectance of the light reflective microparticles is the value measured in the following manner.

### (Regular Reflectance)

The regular reflectance is measured by using a spectrophotometer (Part No.: CM-3500d; manufactured by KONICA MINOLTA INC.). The light reflective microparticles dispersed in an appropriate solvent (water or methyl ethyl ketone) is coated on a glass slide such that the film thickness will be 0.5 mm or more and then dried. The regular reflectance was measured for this obtained glass plate with the coated film when light entered from the glass surface to the coated film at an angle of 45 degrees with respect to the normal line of the glass surface. By measuring the regular reflectance of the case in which the light reflective microparticles are used as the coated film, the reflective performance of the light reflective microparticles can be figured out, taking into consideration of the oxidized state of the surface of the microparticles, or the like.

As for the light reflective microparticles, for example, metallic microparticles such as aluminum, silver, copper, platinum, gold, titanium, nickel, tin, tin-cobalt alloy, indium, and chromium, or metallic microparticles consisted of aluminum oxide and zinc sulfide, bright materials obtained by coating metal or metallic oxide to glass, or bright materials obtained by coating metal or metallic oxide to natural or synthetic mica may be used, depending on the kind of binder to be dispersed into.

Metallic materials used for the metallic microparticles are metals having excellent reflectiveness of the projection light. In particular, the metallic materials have reflectance R in measured wavelength of 550 nm of preferably 50% or more, more preferably 55% or more, further preferably 60% or more, still more preferably 70% or more. In the following, “reflectance R” in the present invention refers to a reflectance when light entered from the vertical direction with respect to the metallic material. Reflectance R can be calculated from the following formula (1), using values of refractive index n and extinction value k which are characteristic values of the metal material. n and k are described in, for example, Handbook of Optical Constants of Solids: Volume 1 (authored by Edward D. Palik) and P. B. Johnson and R. W Christy, PHYSICAL REVIEW B, Vol. 6, No. 12, 4370-4379(1972).

R={(1−n)²+k²}/{(1+n)²+k²} formula (1)

That is to say, reflectance R (550) in measured wavelength of 550 nm can be calculated from n and k measured at wavelength of 550 nm. The metallic material has an absolute value of difference between reflectance R (450) in measured wavelength of 450 nm and reflectance R (650) in wavelength of 650 nm within 25%, preferably within 20%, more preferably within 15%, further preferably within 10% based on reflectance R (650) in measured wavelength 550 nm. The use of such metallic materials will provide excellent reflectiveness and color reproducibility of the entering light.

The metallic material used for the metallic microparticles have a real number term ε′ of an electric permittivity preferably from −60 to 0 and more preferably from −50 to −10. The real number term ε′ of the electric permittivity can be calculated from the following formula (2) using values of the refractive index n and the extinction index k.

ε′=n²−k² formula (2)

The present invention is not restricted by any theory; however, the real number term ε′ of the electric permittivity for the metal material satisfying the above numerical range will generate the following action and it is considered that the transparent light scattering element can be used suitably for the image display device. That is to say, when light enters into the metallic microparticles, an oscilating electric field is generated by light in the metallic microparticles; however, at the same time, a reversed electrical polarization is generated by free electrons, blocking the electric field. When presuming an ideal state that when the real number term ε′ of electric permittivity is 0 or less, light is completely blocked and light cannot enter into the metallic microparticles, i.e., there is no dispersion by a concavoconvex surface and no light absorbance by metallic microparticles, it will mean that light is reflected totally at the surface of the metallic microparticles, and therefore, the reflectiveness of light will be strong. When ε′ is greater than 0, oscillation of the free electrons of the metallic microparticles cannot follow oscillation of light, thus, the oscillating electric field by light cannot be completely denied and light will enter into or transmit through the metallic microparticles. As a result, only a portion of light is reflected at the surface of the metallic microparticles and the reflectiveness of light becomes low.

With respect to the metallic material, preferred are those satisfying the above-described reflectance R and more preferably satisfying the electric permittivity, and also pure metals and alloys can be used. The pure metal is preferably selected from the group consisting of aluminum, silver, platinum, titanium, nickel, and chromium. As for the metallic microparticles, microparticles consisting of those metallic materials and microparticles made by coating those metallic materials onto a resin, a glass, natural or synthetic mica, or the like, can be used. The refractive index n and the extinction index k in each measured wavelength are summarized in Table 1 with respect to various kinds of the metallic materials and the reflectance R and ε′ calculated from such values are summarized in Table 2.

TABLE 1

| metallic | refractive indexn | | | extinction index k | | |
|---|---|---|---|---|---|---|
| materials | n(450) | n(550) | n(650) | k(450) | k(550) | k(650) |
| aluminum | 0.62 | 0.96 | 1.49 | 5.48 | 6.70 | 7.82 |
| silver | 0.15 | 0.12 | 0.14 | 2.48 | 3.35 | 4.15 |
| platinum | 1.85 | 2.13 | 2.38 | 3.15 | 3.72 | 4.25 |
| titanium | 1.70 | 1.89 | 2.22 | 2.27 | 2.62 | 2.99 |
| nickel | 1.64 | 1.77 | 2.02 | 2.66 | 3.26 | 3.82 |
| chromium | 2.34 | 3.17 | 3.10 | 3.14 | 3.33 | 3.33 |
| copper | 1.17 | 0.95 | 0.21 | 2.40 | 2.58 | 3.67 |
| gold | 1.50 | 0.35 | 0.17 | 1.88 | 2.73 | 3.15 |

TABLE 2

| | | | | \|R(450) − R(650)\|/ | Real number term ε′ | | |
|---|---|---|---|---|---|---|---|
| Metallic | Reflectance R | | | R(550) × 100 | of electric permittivity | | |
| materials | R(450) | R(550) | R(650) | [%] | ε′(450) | ε′(550) | ε′(650) |
| aluminum | 0.92 | 0.92 | 0.91 | 1.1 | −29.65 | −43.96 | −58.93 |
| silver | 0.92 | 0.96 | 0.97 | 5.2 | −6.12 | −11.19 | −17.20 |
| platinum | 0.59 | 0.64 | 0.68 | 14.1 | −6.54 | −9.31 | −12.41 |
| titanium | 0.45 | 0.50 | 0.54 | 18.0 | −2.28 | −3.27 | −4.01 |
| nickel | 0.53 | 0.61 | 0.66 | 21.3 | −4.40 | −7.47 | −10.51 |
| chromium | 0.55 | 0.55 | 0.56 | 1.8 | −4.41 | −1.04 | −1.48 |
| copper | 0.55 | 0.64 | 0.94 | 60.9 | −4.39 | −5.74 | −13.42 |
| gold | 0.39 | 0.85 | 0.94 | 64.7 | −1.26 | −7.34 | −9.89 |

The primary particles of the light reflective microparticles have an average diameter of preferably from 0.01 to 100 μm, more preferably from 0.05 to 80 μm, further preferably from 0.1 to 50 μm, further more preferably from 0.5 to 30 μm, and 0.6 to 15 μm. In addition, the average aspect ratio (=the average diameter/the average thickness of the light reflective microparticles) of the light reflective microparticles is preferably from 3 to 800, more preferably from 4 to 700, further preferably from 5 to 600, and further more preferably from 10 to 500. When the average diameter and the average aspect ratio of the light reflective microparticles are within the above ranges, a sufficient scattering effect of the projection light can be obtained without compromising the transmission visibility and thus, a clear laser light beam can be projected. In the present invention, the average diameter of the light reflective microparticles is measured using a laser diffraction particle size distribution measurement apparatus (Part No.: SALD-2300; manufactured by Shimadzu Corporation). The average aspect ratio was calculated from an SEM (Trade Name: SU-1500; manufactured by Hitachi High Technologies Corporation) image.

Commercially available light reflective microparticles can be used, and for example, aluminum powder manufactured by Daiwa Kinzoku Kogyo Co., Ltd., and product name METASHINE manufactured by Matsuo Sangyo Co., Ltd. can be suitable for use.

The content of the light reflective microparticles in the binder can be appropriately adjusted, depending on the regular reflectance of the light reflective microparticles. The content of the light reflective microparticles in the binder is preferably from 0.0001 to 1.0% by mass, preferably from 0.0005 to 0.8% by mass, more preferably from 0.001 to 0.5% by mass, and most preferably from 0.001 to 0.05% by mass, based on the binder. When a transparent light scattering layer is formed by dispersing the light reflective microparticles in the binder in a low concentration as like the above-described ranges, the light emitting from an indication device such as a laser pointer is efficiently scattered and reflected, which makes it possible to satisfy both the clearness of the laser light beam and the visibility of the displayed image.

### (Light Diffusive Microparticles)

The light diffusive microparticles may include completely spherical particles and spherical particles having concavity and convexity or protrusions. As for the light diffusive microparticles having a high refractive index, use can be made to metallic particles obtained from atomizing inorganics, metallic oxides, or metallic salts, preferably having a refractive index from 1.80 to 3.55, more preferably from 1.9 to 3.3, and further preferably from 2.0 to 3.0. The inorganics include, for example, diamond (n=2.42). The metallic oxides include, for example, zirconium oxide (n=2.40), cerium oxide (n=2.20), or the like. The metallic salts include, for example, barium titanate (n=2.40), strontium titanate (n=2.37), or the like. The light diffusive microparticles having a low refractive index include, for example, inorganic particles obtained by atomizing magnesium oxide (n=1.74), barium sulfate (n=1.64), calcium carbonate (n=1.65), or the like, which preferably have a refractive index from 1.35 to 1.80, more preferably from 1.4 to 1.75, and further preferably from 1.45 to 1.7. One kind of these light diffusive microparticles can be used alone or two or more kinds can be used in combination.

The median diameter for the primary particles of the light diffusive microparticles are preferably from 0.1 to 500 nm, more preferably from 0.2 to 300 nm, and further preferably from 0.5 to 200 nm. When the median diameter for the primary particles of the light diffusive microparticles is within the above ranges, a sufficient diffusion effect of the laser light beam can be obtained without compromising the visibility of the displayed image when used as an image display device, and thus, a clear laser light beam can be projected. In the present invention, the median diameter (D₅₀) for the primary particles of the inorganic microparticles can be determined from a particle size distribution measured using a particle size distribution measurement apparatus (manufactured by Otsuka Electronics Co., Ltd., product name: DLS-8000) by a dynamic light scattering method.

The content of the light diffusive microparticles can be appropriately adjusted by the thickness of the transparent light scattering layer or the refractive index of the microparticles. The content of the light diffusive microparticles in the binder is preferably from 0.0001 to 1.0% by mass, more preferably from 0.001 to 0.9% by mass, further preferably from 0.005 to 0.5% by mass, and further more preferably from 0.01 to 0.3% by mass, based on the binder. By dispersing the light diffusive microparticles in the binder within the above ranges and forming the transparent light scattering layer, the clearness of the laser light beam projected from the indication device such as a laser pointer can be attained while ensuring the transparency of the transparent light scattering layer and maintaining the visibility of the image display device.

The light reflective microparticles and the light scattering microparticles are agglomerated into a suitable size that is capable of satisfying the transparency and reflectivity, light scattering property in the transparent light scattering element. Particularly, the average size of the secondary particles of the light reflective microparticles and the light scattering microparticles in the transparent light scattering element is preferably from 100 nm to 200 μm, more preferably from 200 nm to 100 μm, and further preferably from 300 nm to 10 μm. When the average size of the secondary particles is within the above ranges, it is possible to prevent the visualized image light beam from turning bluish and to attain excellent transparency. The average size of the secondary particles is the value obtained by calculating the average value of the particle size when particle size=(particle size in the long axis direction+particle size in the short axis direction)/2, based on the image measured with a scanning electron microscope (SEM, Trade Name: SU-1500; manufactured by Hitachi High Technologies Corporation).

When the thickness of the transparent light scattering layer is represented by t (μm) and the concentration of the light reflective microparticles and/or light diffusive microparticles with respect to the binder is represented by c (% by mass), t and c preferably satisfy the following formula (I):

0.05≤(t×c)≤50 (I),

more preferably the following formula (I-2):

0.1≤(t×c)≤40 (I-2),

further preferably the following formula (I-3):

0.15≤(t×c)≤35 (I-3),

further more preferably the following formula (I-4):

0.3≤(t×c)≤30 (I-4).

When thickness t and concentration c of the transparent light scattering layer satisfy the above-described formula (I), the proportion of the light which is transmitted straight increases (the proportion of the light which does not collide with the microparticles increases) since the microparticles in the binder of the transparent light dispersing layer are in a sparsy dispersed state (the concentration of the microparitcles in the binder is low), and as a result, a clear laser light beam can be projected on the screen without impairing the visibility of the displayed image. When two kinds or more of the light reflective microparticles and/or the light diffusive microparticles are included, concentration c is the total concentration of all the microparticles, and when the transparent light scattering layer is produced by a coating method to be explained below, the thickness t of the transparent light scattering layer is the thickness of the cured film obtainable by curing the binder to which solvent is added. The cured film in the present invention is a transparent film obtained by curing a dispersion liquid in which at least one of the light reflective microparticles or the light diffusive microparticles are dispersed, and when the dispersion liquid comprises a solvent, the film is obtained by removing the solvent from the dispersion liquid and curing the same. Curing in the present invention includes not only the reaction whereby curing occurs by polymerization reaction of monomers or by cross-linking reaction between the polymers by a curing agent, heating, electron beam irradiation, or the like, but also the reaction in which the solvent is removed from the dispersion liquid by heat/calcination and the like and hardness is provided to the binder.

### <Method for Manufacturing Visibility Improvement Film>

The method for manufacturing the visibility improvement film according to the present invention comprises a step for forming the transparent light scattering layer. The step for forming the transparent light scattering layer may be molded and processed by known methods such as extrusion molding which consists of a kneading step and a film-forming step, cast film-forming method, coating method of spin coating, die coating, dip coating, bar coating, flow coating, roll coating, gravure coating, and the like, injection molding, calendar molding, blow molding, compression molding, cell cast method, and the like, and suitable use is made to extrusion molding and injection molding in view of the wide range of formable film thickness, and coating method in view of the easy workability to other shapes than a flat surface. Each step of the extrusion molding is explained in details below.

### (Kneading Step)

The kneading step is a step in which the above-described resin and the microparticles are kneaded to obtain a resin composition. The kneading extruder may be a single- or a twin-screw kneading extruder. When the twin-screw kneading extruder is used in this step, the above-described resin and the microparticles are kneaded while applying a shear stress of preferably from 3 to 1,800 kPa, more preferably from 6 to 1,400 kPa, the values as averages over the whole length of the screw of the twin-screw kneading extruder, to obtain a resin composition. When the shear stress is in the above-described ranges, the microparticles can be sufficiently dispersed in the resin. In particular, when the shear stress is 3 kPa or higher, the dispersion homogeneity of the microparticles can be more improved, and when the shear stress is 1,800 kPa or lower, the resin is prevented from degradation, thereby preventing contamination of air bubbles in the transparent light scattering layer. The shear stress can be set within a desired range by adjusting the twin-screw kneading extruder. In the present invention, the resin composition may be obtained by kneading a mixture of a resin (masterbatch) to which microparticles are added beforehand and a resin with no microparticles added, by means of a single- or a twin-screw kneading extruder. The above description is one example of the kneading step, and a resin (masterbatch) to which the microparticles are added beforehand may be made by using a single screw kneading extruder, or a masterbatch may be made by adding a commonly known dispersing agent.

Conventionally known additives other than the above-described resin and the microparticles may be added to the resin composition, as long as the transmission visibility and the desired optical performance of the visibility improvement film are not compromised. Examples of the additives include an antioxidant, a lubricant, an ultraviolet absorber, a compatibilzer, a nucleating agent, a stabilizer, and the like. The resin and the microparticles are in accordance with the explanations as above.

A twin-screw kneading extruder used in the kneading step comprises a cylinder and two screws inserted therein and it is configured by combining screw elements. For the screw, a flight screw including at least a conveying element and a kneading element can be suitably used. The kneading element preferably includes at least one selected from the group consisting of a kneading element, a mixing element, and a rotary element. By using such a flight screw including a kneading element, the microparticles can be sufficiently dispersed in the resin while applying a desired shear stress.

### (Film Forming Step)

The film forming step is a step in which the resin composition obtained in the kneading step is formed into a film. The film forming method is not particularly limited, and a conventionally known method can be used to form the sheet-form transparent light scattering layer consisted of the resin composition. For example, the resin composition obtained in the kneading step is fed to a melt extruder heated to a temperature (Tm to Tm+70° C.) higher than the melting point to melt the resin composition. For the melt extruder, use can be made to a single-screw kneading extruder, a twin-screw kneading extruder, a vent extruder, a tandem extruder, or the like, depending on the purposes.

Subsequently, the molten resin composition is, for example, extruded into a sheet form by a die such as a T-die, and the extruded sheet-form product is quenched and solidified by a revolving cooling drum or the like, thereby forming a sheet-form molded element. When the film forming step is performed continuously with the above-described kneading step, the resin composition obtained in the kneading step in a molten state can be directly extruded from a die and molded into a sheet-form transparent light scattering layer.

The sheet-form transparent light scattering layer obtained from the film forming process can be further uniaxially stretched or biaxially stretched by a conventionally known method. By stretching the above-described transparent light scattering layer, the mechanical strength can be improved.

The step for forming the transparent light scattering layer involves coating and curing the above-described dispersion liquid on a substrate to form a transparent light scattering layer formed of a cured film, and preferably, curing is performed upon removal of the solvent in the dispersion liquid.

The coating method of the dispersion liquid is not particularly limited, and examples include, coating methods such as roll coating, die coating, air knife coating, blade coating, spin coating, reverse coating, and gravure coating; coating methods by spraying using an air spray device, ink jet device, or an ultrasound spraying device; or printing methods such as gravure printing, screen printing, offset printing, and inkjet printing.

In order to improve the coating property, solvents and the like may be added appropriately to the dispersion liquid. Examples of the solvent include, alcohols such as methanol, ethanol, n-propanol, isopropanol, ethylene glycol, and propylene glycol; ketones such as acetone, methyl ethyl ketone, cyclohexanone, cyclopentanone, and N-methyl-2-pyrrolidone; aromatic carbon hydrides such as toluene, xylene, and tetramethylbenzene; glycol ethers such as cellosolve, methyl cellosolve, ethyl cellosolve, carbitol, methyl carbitol, ethyl carbitol, butyl carbitol, propylene glycol monomethyl ether, propylene glycol monoethyl ether, dipropylene glycol monomethyl ether, dipropylene glycol monoethyl ether, triethylene glycol monomethyl ether, and triethylene glycol monoethyl ether; acetic acid esters such as ethyl acetate, butyl acetate, cellosolve acetate, ethyl cellosolve acetate, butyl cellosolve acetate, carbitol acetate, ethyl carbitol acetate, butyl carbitol acetate, propylene glycol monomethyl ether acetate, propylene glycol monoethyl ether acetate, and 3-methoxybutyl acetate; and others including organic solvents such as methylene chloride, chloroform, chlorobenzene, dichlorobenzene tetrahydrofuran, N,N-dimethyl formamide, and N,N-dimethyl acetamide. The amount of solvent to be added can be appropriately adjusted, depending on the type of binders or microparticles, the desired viscosity range, and the like.

### <Laminate>

The laminate according to the present invention comprises the above-described visibility improvement film and a polarizer. Examples of the polarizer include, without particular limitation, those obtained by absorbing dichroic materials such as iodine or dichroic dye onto hydrophilic polymer films such as a polyvinyl alcoholic film, a partially formalized polyvinyl alcoholic film, ethylene-vinyl acetate copolymer based partially saponified film and uniaxially stretching the film, and polyene oriented films such as a dehydrated product of polyvinyl alcohol or dehydrochlorinated product of polyvinyl chloride. Amongst these, preferred is a polarizer consisted of a polyvinyl alcoholic film and a dichroic material such as iodine, since polarization dichroic ratio is high. The thickness of the polarizer is for example, without particular limitation, from about 5 to 80 μm.

Preferably, the polarizer protection layer to be arranged on one or both sides of the polarizer is generally those having excellent transparency, mechanical strength, thermal stability, moisture shielding, stability of phase-difference value, etc., and for example, is formed preferably from a resin such as triacetyl cellulose, a cycloolefin polymer, and an acryl polymer. As for the acryl polymer which can be used as the polarizer protection layer, preferred is the use of, for example, a resin obtained by copolymerization of methyl methacrylate and maleimide such as N-cyclohexyl maleimide and N-phenylmaleimide, since orientation birefringence and photoelastic birefringence are small, and also moisture shielding is low. The polarization plate used in the present invention is in the form of laminated polarizer protection layers, and may be one commercially available, and use can be made to for example, a polarization plate manufactured and sold by Polatechno Co., Ltd. (polarization degree 99.82%, simplicial transmission: 40%, product name: SHC-125U, with adhesion layer). The laminate regarding the present invention also include an aspect in which the light reflective microparticles and/or the light diffusive microparticles are predispersed in the resin to be the material of the polarizer protection layer when producing the polarizer protection layer, and the polarizer protection layer is made which has a function as a transparent light scattering layer to be laminated on the polarizer. Additionally, the lamimate in relation to the present invention can also be laminated by a substrate, a protection layer, an antireflective layer, and the like, if necessary.

The configuration of the polarizer laminated with the visibility improvement films are for example, without particular limitation, a configuration by laminating a transparent protective film, a polarizer, and a transparent protective film onto the visibility improvement film in this order, or a configuration by laminating a polarizer and a transparent protective film onto the visibility improvement film in this order.

The visibility improvement film of the present invention and various optical members such as a polarization plate using the same can be preferably used in various image display devices such as an electronic black board, a digital signage, CRT, a liquid crystal display (LCD), a plasma display panel (PDP), and an electroluminescent display (ELD). The image display device of the present invention has the similar configuration as the conventional image display device, except that a visibility improvement film of the present invention is used. For example, when the image display device is an LCD, it can be manufactured by appropriately assembling optical members such as a liquid crystal cell and a polarization plate, and if necessary, each component parts such as a lighting system (back light etc.), and then incorporating a driving circuit. The liquid crystal cell is not particularly limited, and various types can be used, such as TN-type, STN-type, n-type, and the like.

### (Laminating Step)

The laminating step is a step in which the polarizer is laminated onto the above-described visibility improvement film. The method for laminating the polarizer can be performed, without particular limitation, by conventionally known methods such as adhesion or lamination.

### (Substrate)

A substrate is used to support the transparent light scattering layer when the transparent light scattering layer is manufactured by a coating method and the like. In particular, as for the substrate, a substrate consisted of inorganic materials such as a metal, ceramics, a soda glass, a quartz glass, a sapphire substrate, quartz, a float plate glass, a silicon substrate, and resin substrates such as polyethylene terephthalate (PET), polyethylene terenaphthalate (PEN), a polycarbonate (PC), a cycloolefin polymer (COP), polymethyl meth(acrylate) (PMMA), polystyrene (PS), polyimide (PI), polyaryate may be used. The substrate is, for example, especially preferably an optically transparent substrate in the optical wavelength range from 400 nm to 780 nm. Surface treatment may be performed or a simplified adhesion layer may be arranged on the substrate, in order to improve the adherence property, and a gas barrier layer can also be arranged on the substrate to prevent entries of moisture and gaseous matter such as oxygen. The thickness of the substrate can be appropriately changed such that its strength becomes suitable, depending on the purpose/the material. The thickness of the substrate may be, for example, in the range from 10 μm to 1 mm (1000 μm), and the substrate may be a thick board of 1 mm or more.

A protection layer is a layer for imparting a function such as light resistance, scratch resistance, and stain resistance. The protection layer is preferably formed by using a resin which does not compromise the transmission visibility or the desired optical property of the image display device. For such a resin, for example, a resin cured by an ultraviolet ray or electron ray, i.e., an ionizing radiation-curable resin, a mixture obtained by adding a thermoplastic resin and a solvent to an ionizing radiation-curable resin, and a thermoset resin may be used. Among these, an ionizing radiation-curable resin is particularly preferable.

For a film forming component of the ionizing radiation-curable resin composition, preferably, those having an acrylate functional group, for example, those containing a relatively large amount of a monofunctional monomer such as ethyl (meth)acrylate, ethylhexyl (meth)acrylate, styrene, methyl styrene, N-vinylpyrrolidone and a polyfunctional monomer, such as polymethylolpropane tri(meth)acrylate, hexane diol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexane diol di(meth)acrylate, neopentyl glycol di(meth)acrylate as an oligomer or a prepolymer of a polyester resin, a polyether resin, an acrylic resin, an epoxy resin, a urethane resin, an alkyd resin, a spiroacetal resin, a polybutadiene resin, a polythiol polyene resin, a (meth)acrylate of a polyfunctional compound such as a polyalcohol and a reactivity diluent having a relatively low molecular weight can be used.

In order to make the above-described ionizing radiation-curable resin composition an ultraviolet light-curable resin composition, acetophenones, benzophenons, Michler's benzoyl benzoates, α-amidoxime esters, tetramethyl thiuram monosulfides, and thioxanthones as photopolymerization initiators, and n-butyl amine, triethylamine, and poly-n-butylphosphine as photosensitizers may be mixed therein to be used. Particularly, preference is made in the present invention to mix, for example, urethane acrylate as an oligomer and dipentaerythritol hexa(meth)acrylate as a monomer.

As for the method to cure the ionizing radiation-curable resin composition, it can be cured by means of a common curing process, i.e., by irradiation of electron ray or ultraviolet ray. For example, when curing with electron ray, use can be made to electron ray having an energy from 50 to 1000 KeV, preferably from 100 to 300 KeV, released from various types of electron beam accelerators such as a Cockcroft-Walton type, a Van de Graaff type, a resonance transforming type, an insulating core transforming type, a linear type, a dynamitron type, a high frequency wave type; and when curing with an ultraviolet ray, use can be made to an ultraviolet ray generated from rays such as an ultrahigh pressure mercury lamp, a low-pressure mercury lamp, a carbon-arc, a xenon-arc, or a metal halide lamp.

The protection layer can be formed by applying a coating liquid of the above-described ionizing radiation (ultraviolet ray)-curable resin composition on the surface of the transparent light scattering layer by a method such as spin coating, die coating, dip coating, bar coating, flow coating, roll coating, or gravure coating, and by curing the coating liquid by means as described above. To the surface of the protection layer, a microstructure such as a concavoconvex structure, a prism structure, or a microlens structure can also be provided depending on the purposes.

### (Reflection Protection Layer)

A reflection protection layer is a layer for preventing reflection from external light. The reflection protection layer may be layered on the surface side (the observer side) of the laminate. The reflection protection layer is preferably formed by using a resin which does not compromise the transmission visibility or the desired optical property of the image display device. For such a resin, for example, a resin cured by an ultraviolet ray/an electron ray, i.e., an ionizing radiation-curable resin, those obtained by adding a thermoplastic resin and a solvent to an ionizing radiation-curable resin, and a thermoset resin can be used. Amongst these, an ionizing radiation-curable resin is particularly preferable. To the surface of the reflection protection layer, a microstructure such as a concavoconvex structure, a prism structure, or a microlens structure can be provided depending on the purposes.

As the method for forming the reflection protection layer, use can be made to, without particular limitation, a dry coating method such as pasting of a coating film, or direct deposition or sputtering on a film substrate, and a wet coating treatment method such as gravure coating, microgravure coating, bar coating, slide die coating, slot die coating, and dip coating.

### <Image Display Device>

The image display device according to the present invention is not particularly limited, as long as the device is capable of displaying an image; and examples of the image display device suitable for use in a presentation and the like include an electronic blackboard, a digital signage, a liquid crystal display and the like.

In the present invention, the configuration of the liquid crystal display includes, without particular limitation, a liquid crystal display arranged with optical members such as a polarization plate, a diffusion plate, and a reflection protection plate, on one side or both sides of the liquid crystal cell, or a liquid crystal display using a back light or a reflection protection plate for the lighting system. The visibility improvement film or the laminate of the present invention can be arranged on one side or both sides of the liquid crystal cell in these liquid crystal displays. When the visibility improvement films or the laminates are arranged on both sides of the liquid crystal cell, they may be the same or different. Further to the liquid crystal display, there can also be arranged for example, various optical members or optical parts such as a diffusion plate, a protection plate, a prism array, a lens array sheet, a light diffusion plate, a back light and the like.

### <Laser Light Irradiation Device>

The laser light irradiation device according to the present invention is not particularly limited, as long as the device is capable of indicating an image by irradiating a laser light beam on the display screen of the image display device; and the example thereof includes a commercially available laser pointer, etc.

### <Video Image Projection System>

The video image projection system according to the present invention comprises an image display device which comprises the above-described visibility improvement film or the above-described laminate, and a projection device. The projection device is not particularly limited, as long as the device is capable of projecting a video image on the screen, and for example, use can be made to a commercially available front projector.

### EXAMPLES

In the following, the present invention will be more specifically described by providing Examples and Comparative Examples; however the present invention should not be construed to be limited to the following Examples.

Methods for measuring the various physicalities and performance evaluation in the Examples and the Comparative Examples are as follows.

### (1) Haze

Haze was measured by using a turbidimeter (Part No.: NDH-5000; manufactured by NIPPON DENSHOKU INDUSTRIES CO., LTD.) in accordance with JIS K 7136.

### (2) Total Light Beam Transmittance

Total light beam transmittance was measured by using a turbidimeter (Part No.: NDH-5000; manufactured by NIPPON DENSHOKU INDUSTRIES CO., LTD.) in accordance with JIS K 7361-1.

### (3) Diffusion Transmittance

Diffusion transmittance was measured by using a turbidimeter (Part No.: NDH-5000; manufactured by NIPPON DENSHOKU INDUSTRIES CO., LTD.) in accordance with JIS K 7361-1.

### (4) Image Clarity

Image clarity is a value of definition (%) when measured by using an image clarity measuring device (Part No.: ICM-IT; manufactured by Suga Test Instruments Co., Ltd.), with an optical comb having a width of 0.125 mm in accordance with JIS K7374. The larger the value of the image definition, the higher is the transmitted image clarity.

### (5) Laser Light Clearness

The laser light clearness was evaluated by displaying an image on an image display device (Interactive Whiteboard D6500, manufactured by RICOH Co., Ltd.), irradiating a laser light beam by using laser pointer ELP-G20 manufactured by KOKUYO Co., Ltd. from a position 1 m away, visually observing the clearness of the laser light beam projected on the image display device, and evaluating based on the following standards.

### [Evaluation Standards]

◯: Laser light beam was clearly visible.

x: Outline of laser light beam was visualized unclearly, or brightness of laser light beam was low and laser light beam was not sufficiently visible.

### (6) Displayed Image Visibility

As like the evaluation of laser light clearness, a laser light beam was irradiated on an image display device displaying an image, the visibility of the image of the irradiated part by the laser light beam was visually observed, and evaluation was made based on the following standards.

### [Evaluation Standards]

◯:A clearly displayed image was visible.

x:Displayed image was hard to see, feeling stressful to visualize.

### (7) Average Particle Size of Secondary Particles

The average particle size of the secondary particles of the light reflective microparticles or the light diffusive microparticles in the transparent light scattering layer was measured by calculating the average value of the particle size when particle size=(particle size in the long axis direction+particle size in the short axis direction)/2, based on the image obtained by use of a scanning electron microscope (SEM) (Trade Name: SU-1500; manufactured by Hitachi High Technologies Corporation).

### <Manufacture of Visibility Improvement Film>

### Example 1

First of all, a thermoplastic resin (PMMA resin, manufactured by Mitsubishi Rayon Co., Ltd., trade name: ACRYPET VH) as a binder and 0.04% by mass of flake-form aluminum microparticles A (light reflective microparticles; average particle size of primary particles: 100 nm; aspect ratio: 300; regular reflectance: 62.8%) based on PMMA pellet were mixed for 30 minutes in a tumbler mixer to obtain a PMMA pellet having a surface to which the flake-form aluminum microparticles are attached homogeneously. The obtained pellets were fed into a hopper of a twin screw kneading extruder equipped with a strand die to obtain a masterbatch in which the flake-form aluminum microparticles are kneaded in at an extrusion temperature of 250° C. The obtained masterbatch and the PMMA pellets (trade name: ACRYPET VH) were mixed homogeneously in a proportion of 1:9, fed into a hopper of a twin screw kneading extruder equipped with a T die, extruded at an extrusion temperature of 250° C. to form a film of a film-form transparent light scattering layer containing 0.004% by mass of flake-form aluminum microparticles A and having a thickness of 75 μm, which was used as it is as a visibility improvement film. The aluminum microparticles A in the manufactured transparent light scattering layer had an average particle size of the secondary particles of 300 nm, haze value of 3.7%, total light beam transmittance of 87%, image clarity of 84%, and t×c=0.3, wherein t represents the thickness of the transparent light scattering layer (μm) and c represents the concentration of the light reflective microparticles (% by mass).

When the obtained visibility improvement film was laminated on an electronic black board and the laser light clearness and the image visibility were evaluated, the outline of the laser light beam was clear and the image of the part where the laser light beam was irradiated was clearly visible without stress.

### Example 2

A transparent light scattering layer having a thickness of 20 μm was made likewise to Example 1, except that the binder PMMA was changed to a polyethylene terephthalate (PET) pellet (manufactured by Bell Polyester Inc., trade name: IFG8L) and silver particles (light reflective microparticles; average particle size of primary particles:1 μm; aspect ratio: 200; regular reflectance: 32.8%) were added in place of the flake-form aluminum microparticles A in an amount of 0.85% by mass based on PET, which was then used as it is as a visibility improvement film. The silver microparticles A in the manufactured transparent light scattering layer had an average particle size of the secondary particles of 1.5 μm, haze value of 5.4%, total light beam transmittance of 70%, resulting in a high transparency. Further, the image clarity was 84% and t×c=17, wherein t represents the thickness of the transparent light scattering layer (μm) and c represents the concentration of the light reflective microparticles (% by mass).

When the obtained visibility improvement film was laminated on an electronic black board and the laser light clearness and the image visibility were evaluated, the outline of the laser light beam was clear and the image of the part where the laser light beam was irradiated was clearly visible without stress.

### Example 3

A transparent light scattering layer having a thickness of 80 μm was made likewise to Example 1, except that zirconium oxide particles (average particle size of primary particles: 10 nm; refractive index: 2.40) were added as light diffusive microparticles in place of the flake-form aluminum microparticles A in an amount of 0.15% by mass based on PMMA, which was then used as it is as a visibility improvement film. The manufactured transparent light scattering layer had a haze value of 9.0% and a total light beam transmittance of 90%, resulting in a high transparency. Further, the image clarity was 80% and t×c=12, wherein t represents the thickness of the transparent light scattering layer (μm) and c represents the concentration of the light diffusive microparticles (% by mass).

When the obtained visibility improvement film was laminated on an electronic black board and the laser light clearness and the image visibility were evaluated, the outline of the laser light beam was clear and the image of the part where the laser light beam was irradiated was clearly visible without stress.

### Example 4

Commercially available polymer acrylate type UV curable resin (UNIDIC V-6841, manufactured by DIC Company) was used as the binder and flake-form aluminum microparticles B (average particle size of primary particles: 10 μm, aspect ratio: 300, regular reflectance: 62.8%) were added as the light reflective microparticles in an amount of 0.001% by mass based on the weight of the solid content in the UV curable resin, and titanium oxide particles (manufactured by TAYCA; median diameter of primary particles: 13 nm; refractive index: 2.72) were added as the light diffusive microparticles in an amount of 0.05% by mass based on the weight of the solid content in the UV curable resin to prepare dispersion liquid A. Further to 100 parts by weight of this dispersion liquid A was added 5 parts by weight of a photopolymerization initiator (manufactured by BASF Japan K.K., Irgacure 184) to obtain dispersion liquid B having a light curing property. The obtained dispersion liquid B was coated on a 3 mm-thick float plate glass by use of a bar coater such that the film thickness will be 10 μm after dried and after drying for 5 minutes in a hot air drying machine at 70° C., a transparent light scattering layer was made by irradiating ultra violet ray which was used as it is as a visibility improvement film. The transparent light scattering layer as made had a haze value of 5.1% and a total light beam transmittance of 84%, resulting in a high transparency. Further the image clarity was 86% and t×c=0.51, wherein t represents the thickness of the transparent light scattering layer (μm) and c represents the concentration of the light diffusive microparticles (% by mass).

When the obtained visibility improvement film was arranged on an electronic black board and the laser light clearness and the image visibility were evaluated, the outline of the laser light beam was clear and the image of the part where the laser light beam was irradiated was clearly visible without stress.

### Example 5

A transparent light scattering layer was made likewise to Example 4, except that commercially available polymer acrylate type UV curable resin (UNIDIC V-6841, manufactured by DIC Company) was used as the binder and flake-form aluminum microparticles A were added as light reflective microparticles in an amount of 0.01% by mass based on the weight of the solid content in the UV curable resin and no light diffusive microparticles were used, which was then used as it is as a visibility improvement film. The transparent light scattering layer as manufactured had a haze value of 6.7%, total light beam transmittance of 79%, resulting in a high transparency. Further, the image clarity was 80% and t×c=0.1, wherein t represents the thickness of the transparent light scattering layer (μm) and c represents the concentration of the light reflective microparticles (% by mass).

When the obtained visibility improvement film was arranged on an electronic black board and the laser light clearness and the image visibility were evaluated, the outline of the laser light beam was clear and the image of the part where the laser light beam was irradiated was clearly visible without stress.

### Example 6

A transparent light scattering layer was made likewise to Example 4, except that commercially available polymer acrylate type UV curable resin (UNIDIC V-6841, manufactured by DIC Company) was used as the binder and nickel microparticles (average particle size of primary particles: 10 μm, aspect ratio: 90, regular reflectance: 16.8%) were added as light reflective microparticles in an amount of 0.05% by mass based on the weight of the solid content in the UV curable resin and no light diffusive microparticles were used, which was then used as it is as a visibility improvement film. The transparent light scattering layer as manufactured had a haze value of 18.5%, total light beam transmittance of 73%, resulting in a high transparency. Further, the image clarity was 76% and t×c=0.5, wherein t represents the thickness of the transparent light scattering layer (μm) and c represents the concentration of the light reflective microparticles (% by mass).

When the obtained visibility improvement film was arranged on an electronic black board and the laser light clearness and the image visibility were evaluated, the outline of the laser light beam was clear and the image of the part where the laser light beam was irradiated was clearly visible without stress.

### Comparative Example 1

A highly transparent film consisting of PMMA was obtained likewise to Example 1 except that no light reflective microparticles were added. The obtained film had a haze value of 2.5%, total light beam transmittance of 93%, and image clarity of 87%.

When the film as made was arranged on an electronic black board and the laser light clearness and the image visibility were evaluated, no laser light beam was visible.

### Comparative Example 2

A highly transparent film was obtained likewise to Example 1 except that an upconversion type luminescent material (lanthanoid containing inorganic microparticles) which was made by the method as described in Patent Document 2, Example 1 was added in place of the light reflective microparticles in an amount of 0.004% by mass based on PMMA. The highly transparent film had a haze value of 3.8%, total light beam transmittance of 88%, and image clarity of 85%.

When the film as made was arranged on an electronic black board and the laser light had low brilliance and was not sufficiently visible.

The results of the various physicalities and performance evaluation of the visibility improvement films as prepared in the Examples and the Comparative Examples are shown in details in Table 3.

TABLE 3

| | | | | | Visibility improvement film | | | | | |
|---|---|---|---|---|---|---|---|---|---|---|
| | Light reflective | | Light diffusive | | | Total | | | | |
| | microparticles | | microparticles | | | light beam | Image | | Lazer | |
| | | Concentration | | Concentration | Haze | transmitance | clarity | | light beam | Image |
| | Type | [% by mass] | Type | [% by mass] | [%] | [%] | [%] | t × c | clearness | visibility |
| Example 1 | aluminum | 0.004 | — | — | 3.7 | 87 | 84 | 0.3 | ∘ | ∘ |
| Example 2 | silver | 0.85 | — | — | 5.4 | 70 | 75 | 17 | ∘ | ∘ |
| Example 3 | — | — | zirconium | 0.15 | 9.0 | 90 | 80 | 12 | ∘ | ∘ |
| | | | oxide | | | | | | | |
| Example 4 | aluminum | 0.001 | titanium | 0.05 | 5.1 | 84 | 86 | 0.51 | ∘ | ∘ |
| | | | oxide | | | | | | | |
| Example 5 | aluminum | 0.01 | — | — | 6.7 | 79 | 80 | 0.1 | ∘ | ∘ |
| Example 6 | nickel | 0.05 | — | — | 18.5 | 73 | 76 | 0.5 | ∘ | ∘ |
| Comparative | — | — | — | — | 2.5 | 93 | 87 | — | x | x |
| Example 1 | | | | | | | | | | |
| Comparative | — | — | — | — | 3.8 | 88 | 85 | — | x | x |
| Example 2 | | | | | | | | | | |

### Manufacturing Example 1

To the visibility improvement film as manufactured in Example 1, a commercially available polarization plate (polarization degree 99.82%, simplicial transmission: 40%, manufactured by Polatechno Co., Ltd., product name: SHC-125U, with adhesion layer) was attached to make a laminate comprising a visibility improvement film and a polarization plate. When the obtained laminate was laminated on an electronic black board and the laser light clearness and the image visibility were evaluated, the outline of the laser light beam was clear and the image of the part where the laser light beam was irradiated was clearly visible without stress.

### DESCRIPTION OF SYMBOLS

10, 20, 30 binder
11, 21, 31 light reflective microparticles
12, 22, 32 light diffusive microparticles
13, 23 transparent light scattering layer
24, 25, 34 polarizer protection layer
26, 35 polarizer
27, 36 polarization plate
33 polarizer protection layer having a function of a transparent light scattering layer

1. A visibility improvement film for use for improving the visibility of laser light beam irradiated on a display screen of an image display device, wherein
the visibility improvement film comprises a transparent light scattering layer comprising a binder, and at least either one of 0.0001 to 1.0% by mass of light reflective microparticles and light diffusive microparticles, based on the binder.

2. The visibility improvement film according to claim 1, wherein
the average particle size of the primary particles of the light reflective microparticles is from 0.01 to 100 μm.

3. The visibility improvement film according to claim 1, wherein
the light reflective microparticles have a shape of a flake form, an average aspect ratio of from 3 to 800, and a regular reflectance of from 12 to 100.

4. The visibility improvement film according to claim 1, wherein
the light reflective microparticles are metallic particles selected from the group consisting of aluminum, silver, platinum, gold, titanium, nickel, tin, indium, chromium, titanium oxide, aluminum oxide, and zinc sulfide, bright materials of glass coated with metal or metallic oxides, or bright materials of natural or synthetic mica coated with metal or metallic oxides.

5. The visibility improvement film according to claim 1, wherein
the difference between refractive index n₂ of the light diffusive microparticles and refractive index n₁ of the binder satisfies the following formula (1):

|n₁−n₂|≥0.1 (1).

6. The visibility improvement film according to claim 1, wherein
the light diffusive microparticles are at least one selected from the group consisting of zirconium oxide, zinc oxide, titanium oxide, cerium oxide, barium titanate, strontium titanate, magnesium oxide, calcium carbonate, barium sulfate, and diamond.

7. The visibility improvement film according to claim 1 wherein
the light diffusive microparticles have a median diameter of the primary particles of from 0.1 to 500 nm.

8. The visibility improvement film according to claim 1 wherein
the haze is 35% or less.

9. A laminate comprising the visibility improvement film according to claim 1 and a polarizer.

10. An image display device comprising the visibility improvement film according to claim 1.

11. A video image projection system comprising the image display device comprising the visibility improvement film according to claim 1.
